(19) United States
(12) Patent Application Publication
(10) Pub. No.: US 2026/0014678 A1
(43) Pub. Date: Jan. 15, 2026

(54) NUT ROTATION ASSISTANCE TOOL

(71) Applicant: Moonface, Inc., Anjo-shi (JP)

(72) Inventor: Takuro ABE, Anjo-shi (JP)

(21) Appl. No.: 19/225,272

(22) Filed: Jun. 2, 2025

(30) Foreign Application Priority Data
Jul. 9, 2024 (JP) 2024-110609

(51) Int. Cl. B25B 13/48

(52) U.S. Cl. CPC B25B 13/481

(57) ABSTRACT

A nut rotation assistance tool (1), such as a socket designed to be rotated by a wrench (90a; 90b), assists in simultaneously rotating a main nut (70A) and a jam nut (70B) about a bolt (60). An operating portion (30) is defined at a first end portion of a tubular main body portion (20), and a driven portion (40) is defined at a second end portion thereof. The operating portion includes a deep polygonal hole (30A) and a shallow polygonal hole (30B) that axially overlap but are circumferentially offset. The deep hole has a first axial depth that is at least greater than the axial thickness of the jam nut, whereas the shallow hole has a second axial depth that is equal to or less than the axial thickness of the jam nut, such that only the jam nut can be, partially or completely, accommodated in the shallow hole.

### CROSS-REFERENCE TO RELATED APPLICATION

This application claims priority to Japanese patent application no. 2024-110609, filed on Jul. 9, 2024, the contents of which are fully incorporated herein by reference.

### BACKGROUND OF THE INVENTION

### 1. Field of the Invention

The present invention relates to a nut rotation assistance tool, e.g., a socket to be rotatably driven by a hand wrench (spanner) or ratcheting socket wrench, that assists in rotating, e.g., one or more nuts.

### 2. Description of the Related Art

Bolts and nuts are often used to fasten (join) together many types of structural members, e.g., in automobiles. Nut rotating tools, such as wrenches (spanners) or the like, are often used to rotate and thereby tighten or loosen nuts. More specifically, a distal end portion of the wrench is mated with the nut or the head of the bolt, and a user grips and repeatedly turns (pivots) a base end portion of the wrench to turn (rotate) the nut or bolt. By repeatedly performing this turning (pivoting) operation, the nut is tightened or loosened. Of course, a ratchet socket wrench may be used to rotate the nut or bolt.

When tightening or loosening a nut, the wrench pivots in a fan-like shape about the nut. However, in case various types of structural members are arranged, e.g., in a complicated manner, there might not be sufficient space to permit such fan-like movement of the wrench, in which case the pivot angle of each turn of the wrench will be smaller than desirable. That is, the nut (or bolt) can only be turned by a relatively small angle during each pivot movement. In this case, it becomes necessary to repeatedly pivot the wrench many times, a little each time, which is slow and thus inefficient.

Furthermore, there are situations in which two nuts are serially and adjacently screwed onto a single bolt. An example of such a situation is when two nuts, namely a main nut and a jam nut, are screwed onto a bolt, or the like, so that the jam nut securely holds the tightened position of the main nut. More specifically, when the main nut is positioned at a predetermined position (e.g., it has been tightened with an appropriate amount of torque), loosening of the main nut is impeded by tightly fastening the adjacent jam nut against the main nut. When using a main nut and a jam nut, there are situations in which only the jam nut is rotated in the final stage of tightening, and there are other situations in which simultaneous rotation of both nuts is preferable to increase the overall tightening (fastening) efficiency (speed). However, if one wrench needs to be used for rotating only one nut, and a second wrench needs to be used to rotate two nuts at the same time, tightening (fastening) will be inefficient due to the need to switch wrenches.

Here, it is noted that Japanese Patent Application Publication No. 2009-113191 discloses a conventional type of tool for tightening nuts and bolts.

### SUMMARY OF THE INVENTION

It is one non-limiting object of the present teachings to disclose techniques for more efficiently rotating one or two nuts even if there is a complicated arrangement of structural members or the like, in which sufficient space for a nut rotating tool (e.g., a wrench or spanner) to pivot in a wide range is not available. It is another non-limiting object of the present teachings to disclose techniques for enabling efficient rotation of two nuts that are serially arrayed on (along) a single axial line, e.g., when two nuts are to be tightened onto a single bolt, and error-free tightening of one nut (jam nut) thereafter.

In a first aspect of the present teachings, a nut rotation assistance tool is configured to assist in rotating a first nut and a second nut that are serially arranged on the same axial line, e.g., to tighten or loosen the first and second nuts screwed onto a bolt. The nut rotation assistance tool may comprise a main body portion that extends in a longitudinal direction and has a first longitudinal end portion and a second longitudinal end portion, an operating portion located at the first longitudinal end portion and configured to receive (mate with) both the first nut and the second nut, and a driven portion located at the second longitudinal end portion and configured to receiving a turning force from a nut rotating tool, such as a wrench or spanner. The operating portion preferably includes a deep polygonal hole and a shallow polygonal hole. The deep polygonal hole has a first axial depth that corresponds to or is deeper than a total thickness of the first nut and the second nut that are disposed in a state in which the outer contours of the first and second nuts are aligned in an axial direction of the nut rotation assistance tool; alternately, the first axial depth is at least greater than the axial thickness of the second nut (jam nut) and is sufficient to entirely receive the second nut while at least also partially (preferably completely) accommodating the first nut (main nut). On the other hand, the shallow polygonal hole has a second axial depth that corresponds to only the axial thickness of the second nut, or is equal to or less than the axial thickness of the second nut. Thus, only the second nut can be received in the shallow polygonal hole. The deep polygonal hole and the shallow polygonal hole overlap in the axial direction (are formed concentrically) but vertices of the deep and shallow polygonal holes are circumferentially offset about an axial center line of the main body portion.

In a second aspect of the present teachings, a nut rotation assistance tool is configured to assist in rotating a first nut and a second nut that are serially arranged on the same axial line, e.g., to tighten or loosen the first and second nuts screwed onto a bolt. The nut rotation assistance tool may comprise a main body portion that extends in a longitudinal direction and has a first longitudinal end portion and a second longitudinal end portion, an operating portion located at the first longitudinal end portion and configured to receive (mate with) both the first nut and the second nut, and a driven portion located at the second longitudinal end portion and configured to receiving a turning force from a nut rotating tool, such as a wrench or spanner. The operating portion may include a deep polygonal hole and a shallow polygonal hole. While the first nut and the second nut are in a state in which vertices of the outer contour of the first and second nuts match each other (i.e. the outer shapes (contours) of the nuts are aligned in the axial direction), the deep polygonal hole has a sufficient depth to entirely accommodate (receive) the second nut and also at least partially (preferably completely) accommodate the first nut, so that both of the first and second nuts are turnable together when turning the nut rotation assistance tool around an axial center line of the main body portion. On the other hand, the shallow polygonal hole has a depth that accommodates only the second nut (or a portion thereof), such that only the second nut can be tightened when the second nut is disposed in the shallow polygonal hole. The deep polygonal hole and the shallow polygonal hole overlap in the axial direction (are formed concentrically) but vertices of the deep and shallow polygonal holes are circumferentially offset about the axial center line of the main body portion.

In the first and second aspects of the present teachings, the vertices of the deep and shallow polygonal holes may be circumferentially offset about the axial center line of the main body portion, e.g., by 30 degrees.

The nut rotation assistance tool according to the first and second aspects is turned using a nut rotation tool (e.g., a wrench (spanner) or ratchet socket wrench) that mates with the driven portion in a state in which the nut(s) (i.e. both the first nut and the second nut, or only the second nut) has (have) been fitted into the operating portion. Thus, when the nut rotation assistance tool turns around its axial center line, the nut(s) turn(s) in the same direction. Thus, even in a situation in which a complicated arrangement of structural members or the like does not allow for sufficient space to pivot the nut rotation tool in the same plane as the head of the nut(s), because the nut rotation tool is spaced apart from the nut(s) by the nut rotation assistance tool, sufficient pivoting space can be provided at a location that is spaced apart from the nut(s). Accordingly, the nut(s) can be more efficiently rotated.

With the nut rotation assistance tool according to the first and second aspects, both nuts may be fitted into the deep polygonal hole in a state in which the phases (vertices) of the first nut and the second nut in a direction about the same axial line match each other (i.e. the peripheral shapes of the nuts are aligned in the axial direction), and then both nuts are rotated at the same time. However, only the second nut can be fitted into the shallow polygonal hole, and only the second nut is rotated when the shallow polygonal hole is used for a tightening or loosening operation. Accordingly, rotating both nuts at the same time, or rotating only the second nut, can be performed using the same nut rotation assistance tool, thereby enabling efficient and error-free tightening and loosening of both a single nut as well as two nuts that are axially adjacent to each other.

In a third aspect of the present teachings, the nut rotation assistance tool may include at least one indicator that is formed or defined on the outer peripheral surface of the main body portion or of the operating portion and is configured such that a tool user can visually and/or tactilely identify the locations (more specifically, the vertices) of the deep polygonal hole and the shallow polygonal hole within the operating portion. That is, the deep polygonal hole has an inner peripheral surface that is configured to receive both the first nut and the second nut at the same time. For example, the deep polygonal hole may have a hexagonal internal shape that is the same as the hexagonal shape of the outer peripheral surface of the first and second nuts. The shallow polygonal hole has a shape and depth that permits only one nut to be received therein. The inner peripheral surface of the shallow hole may have, e.g., a 12 point (vertex) star polygon shape, which is also known as a dodecagram, more specifically a regular dodecagram. In such an embodiment, six of the twelve vertices of the dodecagram are common with the hexagonal shape of the deep hole. The other six of the twelve vertices of the dodecagram have a radially inwardly protruding step or shoulder at a depth from the end of the first longitudinal end portion that is no more than the thickness of one of the nuts, so that only one nut (i.e. a jam nut) can fit into the shallow polygonal hole.

The nut rotation assistance tool according to this third aspect yields the following advantageous functions and effects in addition to the advantageous functions and effects of the nut rotation assistance tool according to the first or second aspects. For example, a tool user can visually and/or tactilely identify the orientations (i.e. vertices) of the deep polygonal hole and the shallow polygonal hole based on the indicator(s) formed on the main body portion. Thus, the advantageous functions and effects of the nut rotation assistance tool according to the first or second aspects can be obtained in a reliable manner, without confusion concerning whether the deep polygonal hole or the shallow polygonal hole is being used to rotate the nut(s).

In a fourth aspect of the present teachings, at least one convex portion and/or at least one concave portion may be formed or defined on a peripheral wall (outer) surface of the main body portion or of the operating portion, corresponding to at least one of the deep polygonal hole and the shallow polygonal hole. The convex portion(s) and the concave portion(s) may function as indicator(s) in accordance with the above-described third aspect.

Here, the term “convex portion(s)” includes, e.g., one or more “protruding portions” or protrusion(s), and the term “concave portion(s)” includes, e.g., one or more “groove portions” or groove(s).

The nut rotation assistance tool according to this fourth aspect provides the same advantageous functions and effects as the third aspect, because the convex portion(s) and/or the concave portion(s) serve(s) as visual and/or tactile indicator(s) of the orientation (vertices) of the deep polygonal hole and/or of the shallow polygonal hole.

In a fifth aspect of the present teachings, one or more protruding portions and/or one or more groove portion(s) having a difference in length corresponding to a difference in depths of the deep polygonal hole and the shallow polygonal hole may be formed or defined on a peripheral wall (outer) surface of the main body portion or of the operating portion, corresponding to the deep polygonal hole and/or the shallow polygonal hole. The protruding portion(s) and the groove portion(s) may function as indicator(s) in accordance with the above-described third aspect.

An example of “one or more protruding portions and/or one or more groove portions having a length corresponding to a difference in depths of the deep polygonal hole and the shallow polygonal hole is formed” is “one or more protruding portions and/or one or more groove portions having a length corresponding to depths of each of the deep polygonal hole and the shallow polygonal hole is (are) formed”. However, this arrangement is not restrictive, and it is also possible to provide “one or more protruding portions and/or one or more groove portions formed corresponding to the deep polygonal hole is (are) longer than one or more protruding portions and/or one or more groove portions formed corresponding to the shallow polygonal hole”.

The nut rotation assistance tool according to this aspect provides the same advantageous functions and effects as the third aspect, because the protruding portion(s) and/or the groove portion(s) serve(s) as visual and/or tactile indicator(s) of the orientation (vertices) of the deep polygonal hole and/or the shallow polygonal hole.

In a sixth aspect of the present teachings, the driven portion may comprise a polygonal post extending from the main body portion, and a polygonal hole formed in the polygonal post.

Here, the term “polygonal post” includes, e.g., a “hexagonal post”, a “square post”, etc. The term “polygonal hole” likewise includes a “hexagonal hole”, a “square hole”, etc.

The nut rotation assistance tool according to this aspect yields the following advantageous functions and effects in addition to the advantageous functions and effects of the nut rotation assistance tool according to any one of the first to fifth aspects. That is, a polygonal post and a polygonal hole are formed on the driven portion, and accordingly any nut rotation tool capable of mating with the polygonal post and/or the polygonal hole can be used to rotate the nut rotation assistance tool in order to tighten or loosen the nut(s) on a bolt.

### BRIEF DESCRIPTION OF THE DRAWINGS

FIGS. 1a and 1b are perspective views of a nut rotation assistance tool according to a first, representative embodiment of the present teachings, as viewed from different angles;

FIGS. 2Aa to 2Ad3 are various views illustrating the nut rotation assistance tool according to the first embodiment of the present teachings, in which FIG. 2Aa is a side view, FIG. 2Ab1 is a view of the nut rotation assistance tool shown in FIG. 2Aa as viewed from the right, FIG. 2Ab2 is a view of the nut rotation assistance tool shown in FIG. 2Aa as viewed from the left, FIG. 2Ac is a longitudinal-sectional view of the nut rotation assistance tool shown in FIG. 2Aa, and FIGS. 2Ad1 to 2Ad3 are cross-sectional views taken along line I-I, line II-II, and line III-III in FIG. 2Ac, respectively;

FIGS. 2Ba to 2Bd3 are views illustrating the nut rotation assistance tool according to the first embodiment of the present teachings, in which FIG. 2Ba is a plan view thereof, FIG. 2Bb1 is a view of FIG. 2Ba as viewed from the right, FIG. 2Bb2 is a view of FIG. 2Ba as viewed from the left, FIG. 2Bc is a longitudinal-sectional view of FIG. 2Ba, and FIGS. 2Bd1 to 2Bd3 are cross-sectional views taken along line I-I, line II-II, and line III-III in FIG. 2Bc, respectively;

FIG. 3Aa is an enlarged perspective view illustrating a portion of the nut rotation assistance tool according to the first embodiment of the present teachings;

FIG. 3Ab is an enlarged frontal view illustrating the nut rotation assistance tool according to the first embodiment of the present teachings (an enlarged view of FIG. 2Ab1) in which a shallow polygonal hole (hereinafter, simply “shallow hole”) is illustrated by solid lines and dash-double-dot lines;

FIGS. 3B1 to 3B3 are respectively partial enlarged views of FIGS. 2Ad1 to 2Ad3, with a deep polygonal hole (hereinafter, simply “deep hole”) being illustrated by solid lines and dash-dot lines, and the shallow hole being illustrated by solid lines and dash-double-dot lines in FIG. 3B1;

FIGS. 4Aa to 4Ac are views illustrating a method for using the nut rotation assistance tool according to the first embodiment of the present teachings, illustrating a state in which two nuts are rotated using the deep hole, in which FIG. 4Aa is a perspective view illustrating a state immediately prior to fitting (inserting) the two nuts into the deep hole, FIG. 4Ab is a perspective view illustrating a fitted state, and FIG. 4Ac is a longitudinal sectional view thereof;

FIGS. 4Ba to 4Bc are views illustrating a method for using the nut rotation assistance tool according to the first embodiment of the present teachings, illustrating a state in which only a jam nut is rotated using the shallow hole, in which FIG. 4Ba is a perspective view illustrating a state immediately prior to fitting (inserting) the jam nut into the shallow hole, FIG. 4Bb is a perspective view illustrating a fitted state, and FIG. 4Bc is a longitudinal sectional view thereof;

FIGS. 5Aa and 5Ab are views illustrating a method for using the nut rotation assistance tool according to the first embodiment of the present teachings, illustrating a state in which a first driven portion is turned by a hand wrench, in which FIG. 5Aa is a perspective view illustrating a state immediately prior to use, and FIG. 5Ab is a perspective view illustrating a state in use;

FIGS. 5Ba and 5Bb are views illustrating a method for using the nut rotation assistance tool according to the first embodiment of the present teachings, illustrating a state in which a second driven portion is turned by a ratchet socket wrench, in which FIG. 5Ba is a perspective view illustrating a state immediately prior to use, and FIG. 5Bb is a perspective view illustrating a state in use;

FIGS. 6a and 6b are views illustrating the entirety of a method of the nut rotation assistance tool according to the first embodiment of the present teachings, in which FIG. 6a is a perspective view illustrating a state immediately prior to use, and FIG. 6b is a perspective view illustrating a state in use;

FIG. 7 is a view illustrating a modification of the first embodiment of the present teachings, and is a cross-sectional view corresponding to FIG. 4Ac;

FIG. 8 is a view illustrating another modification of the first embodiment of the present teachings, and is a cross-sectional view corresponding to FIG. 4Bc; and

FIGS. 9a and 9b are view illustrating another modification of the first embodiment of the present teachings, in which FIG. 9a is a cross-sectional view corresponding to FIG. 3Aa, and FIG. 9b is a cross-sectional view corresponding to FIG. 3B1.

### DESCRIPTION OF THE PREFERRED EMBODIMENTS

### First Embodiment

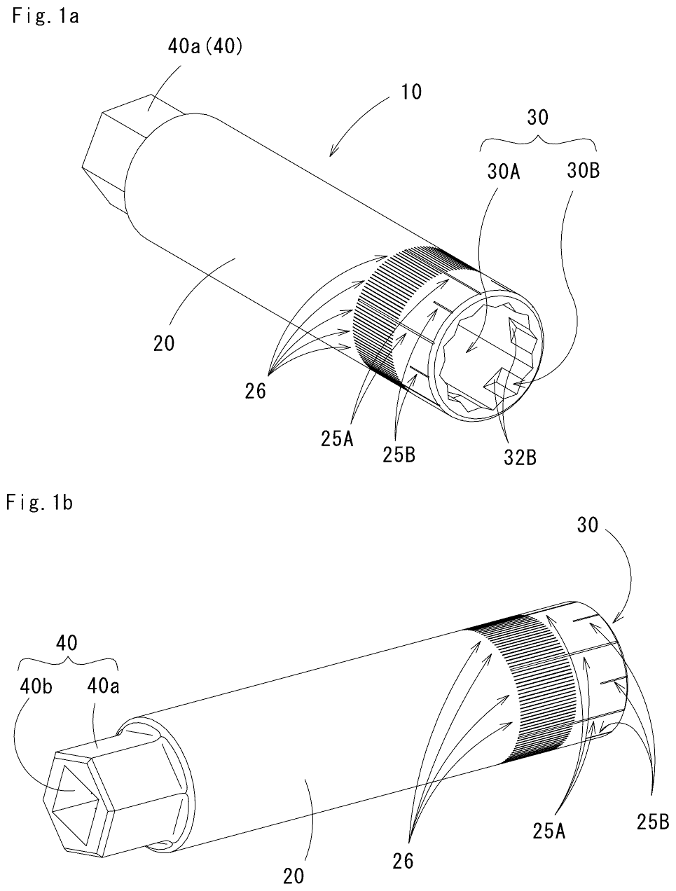

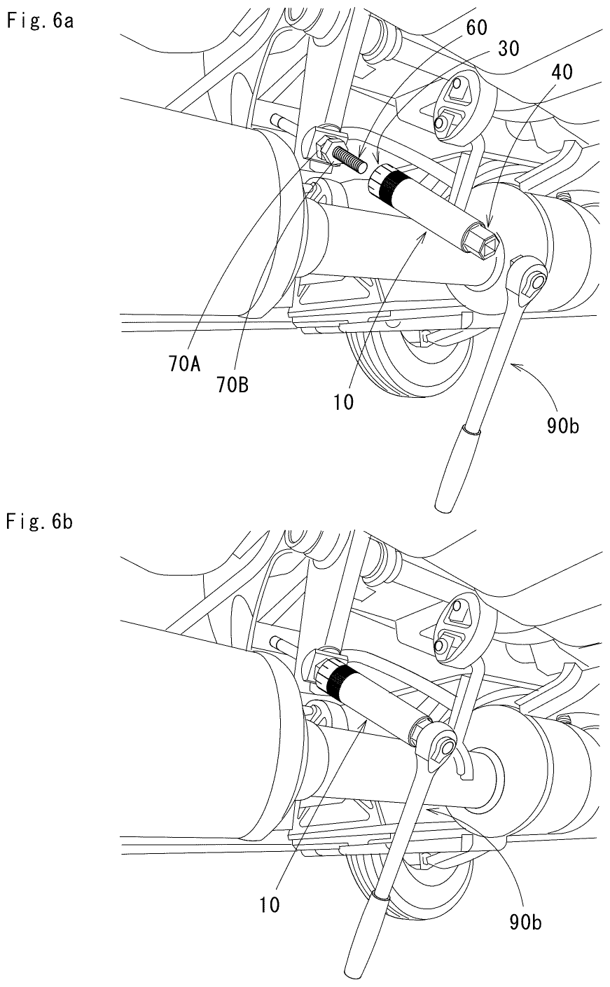

Next, a first, non-limiting embodiment of the present teachings will be described with reference to the drawings, with reference to FIGS. 1a to 6b. As illustrated in FIGS. 6a and 6b, a nut rotation assistance tool 10 is designed to be capable of rotating two nuts 70A and 70B (i.e. a main nut 70A and a jam nut 70B that are serially arranged) with respect to a single bolt 60. Note that, in the following, “nut rotation assistance tool 10” may also be referred to simply as “rotation assistance tool 10”. The “main nut 70A” corresponds to a “first nut” of the present teachings, and the “jam nut 70B” corresponds to a “second nut” of the present teachings. Also, the bolt 60 (a center axial line thereof) corresponds to or defines a “same axial line” of the present teachings.

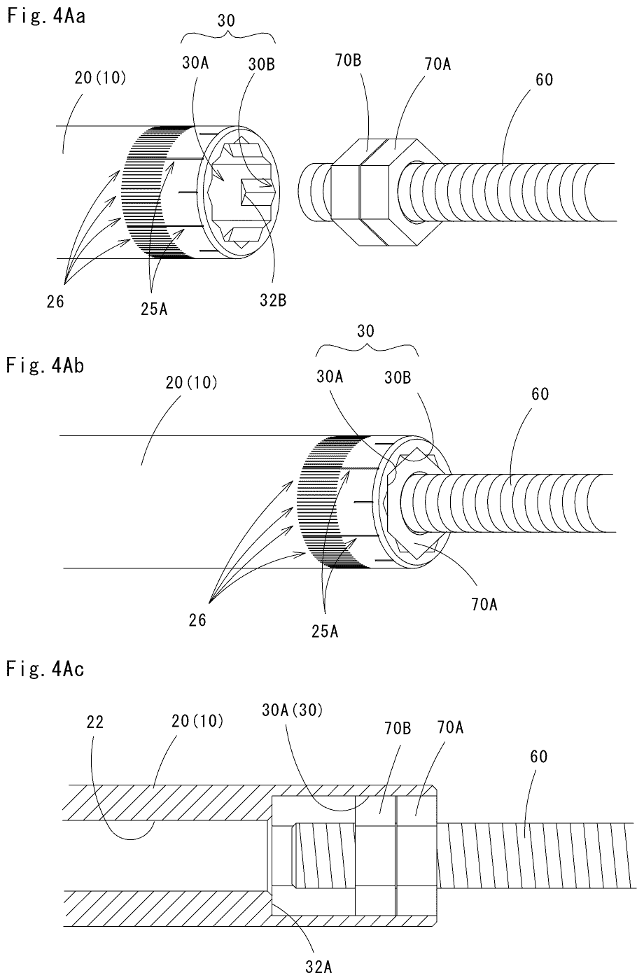

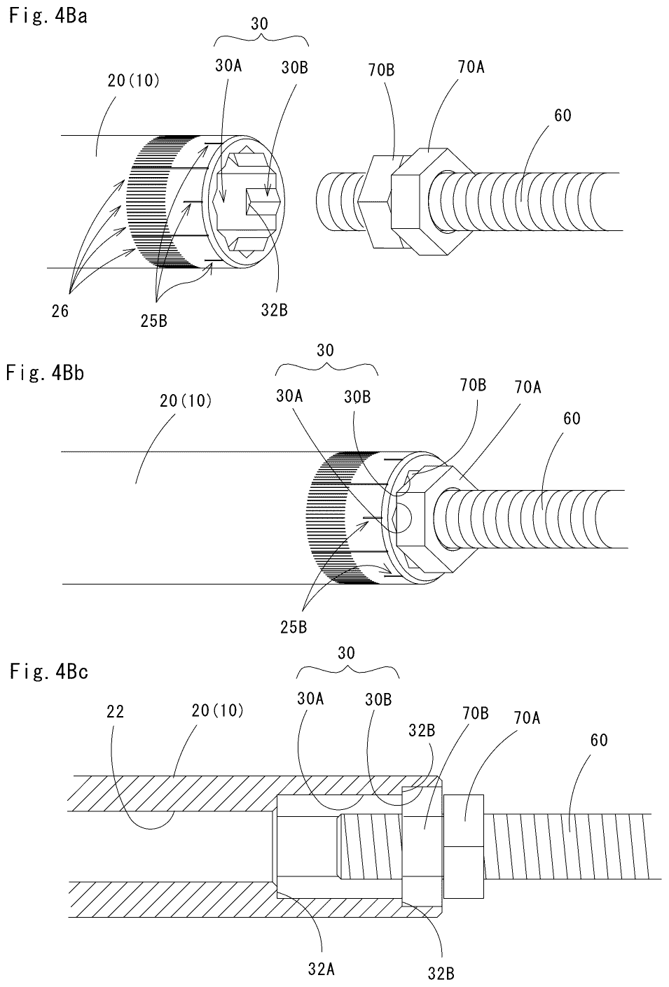

The jam nut 70B is designed to come into close (tight) contact with the main nut 70A that is positioned at a predetermined position with respect to the bolt 60, so as to impede the main nut 70A from loosening and thereby deviating from the predetermined (desired fastening) position. In other words, the jam nut (second nut) is screwed down hard (tightly) against a first nut to prevent the first nut from slacking back (loosening). As illustrated in FIG. 4Aa, the main nut 70A and the jam nut 70B each have a regular hexagonal shape of the same size, and have the same thickness (length in the axial direction).

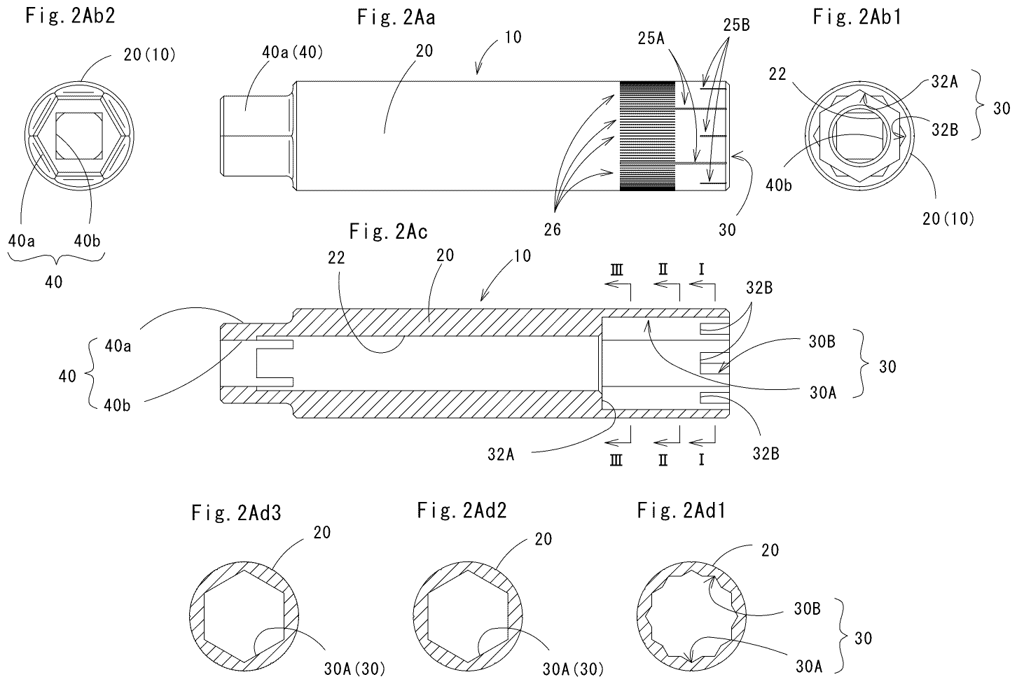

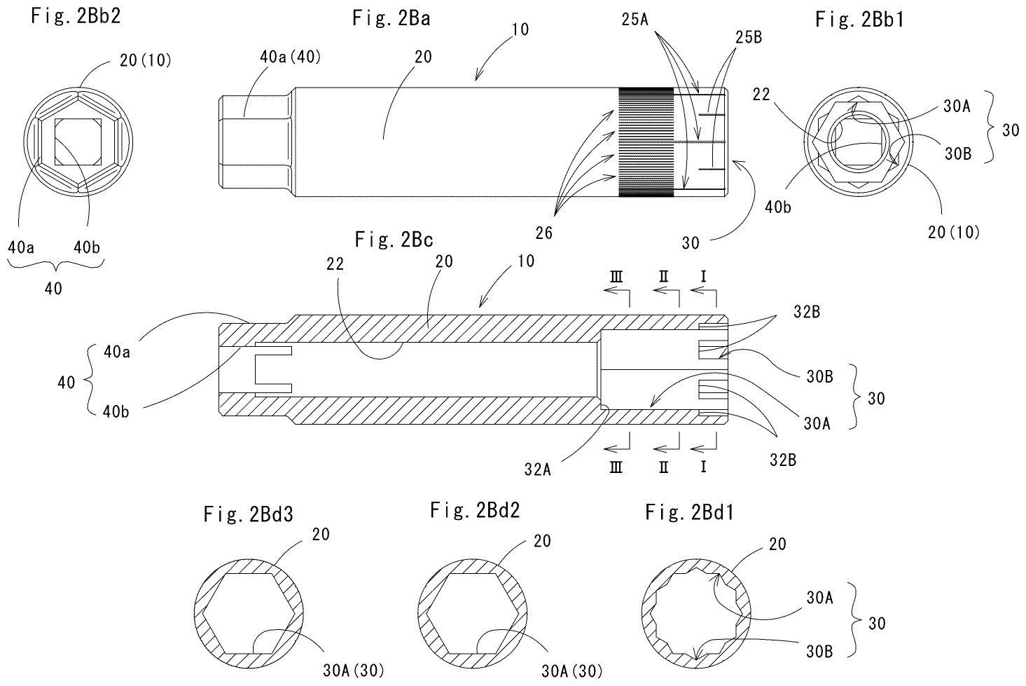

As illustrated in FIGS. 1a to 2Bd3, the rotation assistance tool 10 has a substantially tubular shape overall, and extends in one (longitudinal or axial) direction. The rotation assistance tool 10 is preferably in the form of a socket that is rotated by a hand wrench or more preferably by a socket wrench, e.g., having a square drive. The rotation assistance tool 10 includes a main body portion 20 having a tubular shape, an operating portion (socket opening) 30 formed at one longitudinal end portion (first end portion) thereof and a driven portion (drive end) 40 formed at the other longitudinal end portion (second end portion) thereof. The main body portion 20 has a peripheral wall (outer) surface (reference sign omitted) having a circular cross-section. A through hole 22 is formed (extends) along the axial center line of the main body portion 20 (see FIGS. 2Ac and 2Bc); the through hole 22 passes through (communicates with) the operating portion 30 and the driven portion 40. Within the main body portion 20, the through hole 22 has a circular cross-section (see FIGS. 2Ab1 and 2Bb1), although the shape of the hole within the main body portion 10 is not particularly limited.

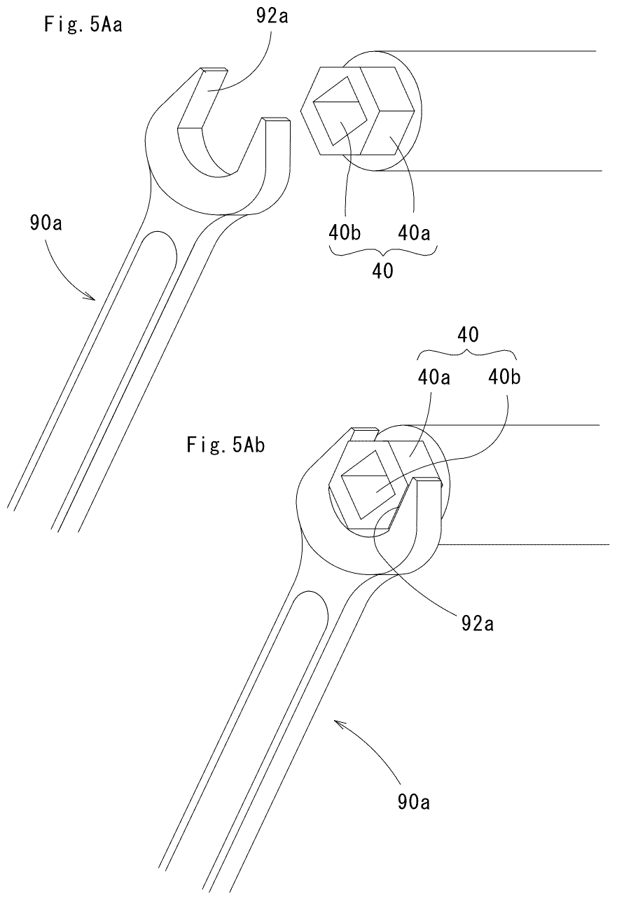

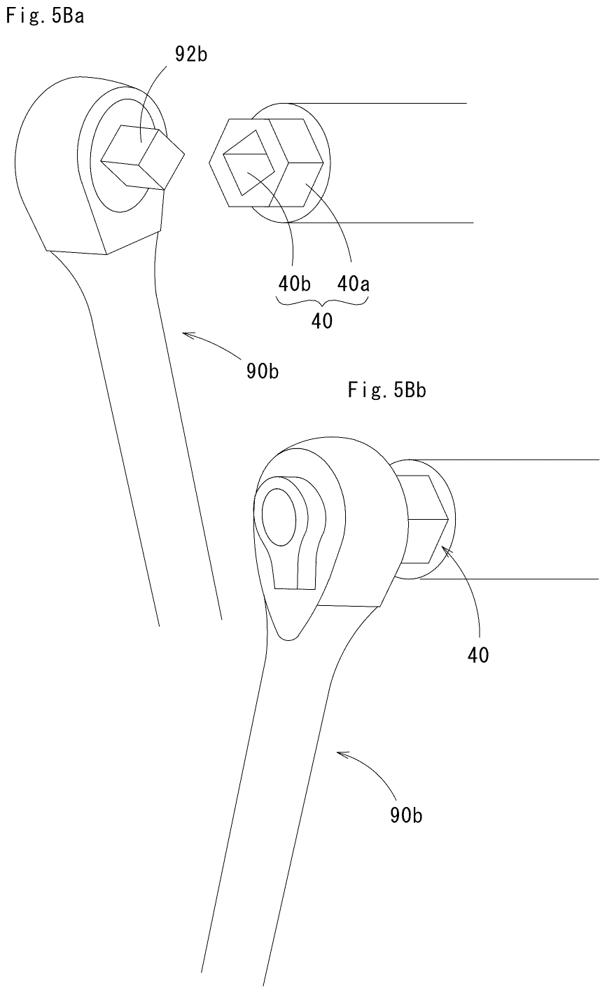

As illustrated in FIGS. 4Aa to 4Bc, the operating portion 30 has an internal shape (inner peripheral surface) that corresponds to the heads of the nuts 70A and 70B; i.e. the inner surface of one portion (i.e. a deeper portion) of the operating portion 30 and the outer surface of the heads of the nuts 70A, 70B are both hexagonal and have the same size in the cross-section perpendicular to the center axis line of the rotation assistance tool 10. As illustrated in FIGS. 5Aa to 5Bb, the driven portion 40 is configured to receive a turning (rotational) force from a nut rotation tool such as a wrench (e.g., an open-end wrench 90a (FIG. 5Aa) or a square-head (square drive) socket wrench 90b (FIG. 5Ba)) or the like. Both of the main nut 70A and the jam nut 70B (FIGS. 4Aa to 4Ac) are, or only the jam nut 70B (FIGS. 4Ba to 4Bc) is, fitted (interference fit) in the operating portion 30 (FIGS. 4Aa to 4Bc), as will be further explained below. The driven portion 40 is then subjected to a turning force by the wrench 90a or 90b (FIGS. 5Aa to 5Bb), whereby the entire rotation assistance tool 10 (FIGS. 6a and 6b) is turned (rotated) about its own axis, thereby causing the nut (either both nuts 70A and 70B, or the jam nut 70B alone) to turn to either fasten (tighten) or loosen the nut(s).

As described above with reference to FIGS. 4Aa to 4Bc, the operating portion 30 (FIG. 1a) has an internal shape that corresponds to the nuts 70A and 70B (FIGS. 6a and 6b), and the first longitudinal end portion is formed with a hole that leads (extends) toward the second end portion of the rotation assistance tool 10. That is to say, the operating portion 30 has a hollow shape that opens at the first longitudinal end portion of the rotation assistance tool 10.

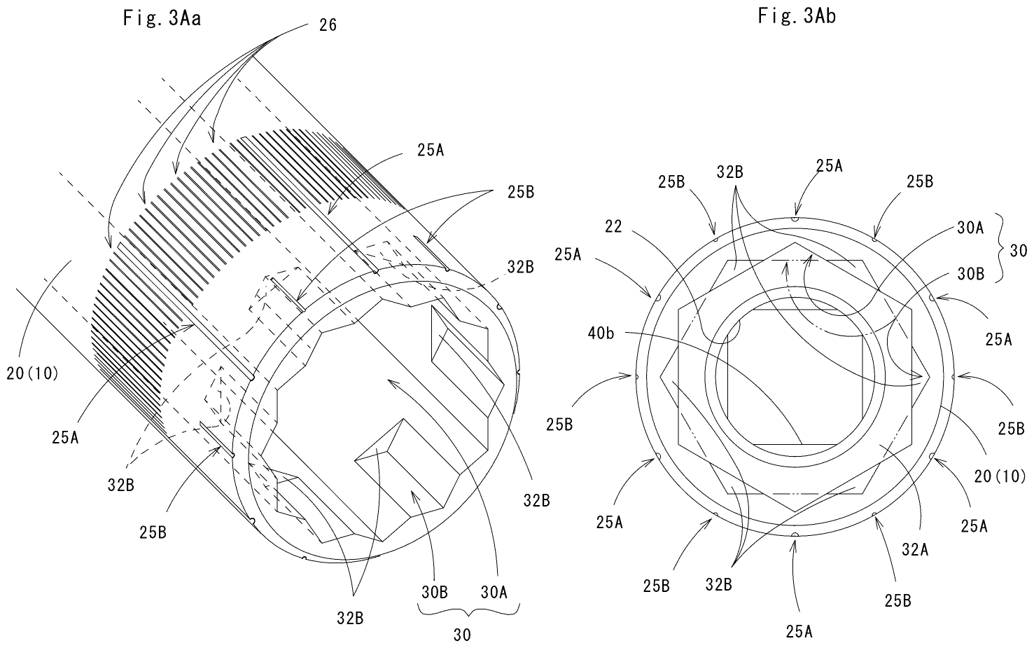

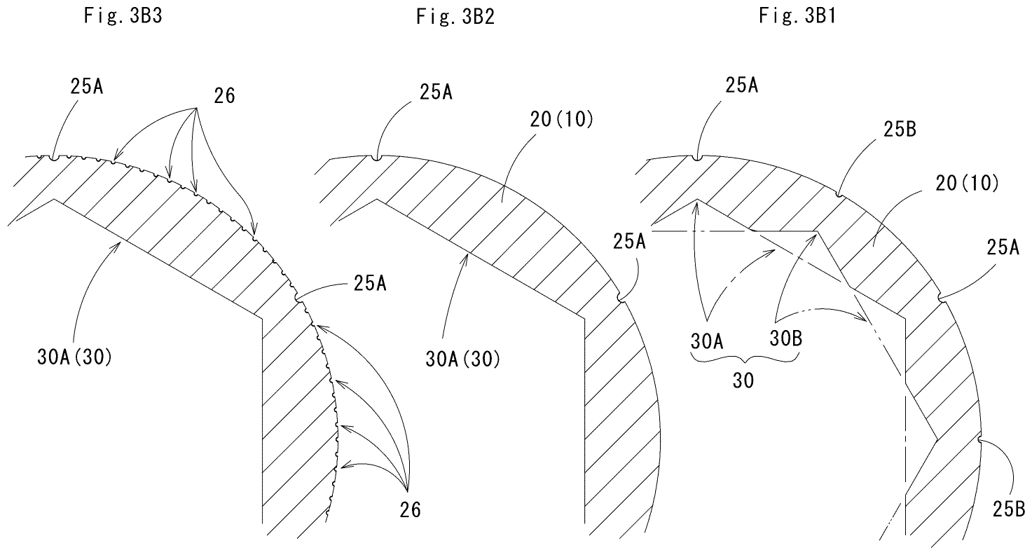

As illustrated, e.g., in FIGS. 2Aa to 4Bc, the operating portion 30 has a deep polygonal hole 30A (hereinafter, simply “deep hole 30A”) and a shallow polygonal hole 30B (hereinafter, simply “shallow hole 30B”). The deep hole 30A is configured to hold (and rotate) both nuts 70A and 70B, whereas the shallow hole 30B is configured to hold (and rotate) only one of the nuts, typically the jam nut 70B. The deep hole 30A and the shallow hole 30B each have (define) a regular hexagonal cross-section that is sized to correspond to (hold, accommodate) both nuts 70A and 70B (FIGS. 4Aa to 4Bc). The deep hole 30A and the shallow hole 30B are formed concentrically (i.e., the holes 30A, 30B share a common axial center line) and overlap in the axial direction, and both holes 30A, 30B extend in a lengthwise (longitudinal) direction of the main body portion 20. As illustrated, e.g., in FIGS. 3Ab and 3B1, the phase (vertices) of the deep hole 30A (i.e. the hexagonal shape thereof) does not coincide with the phase (vertices) of the shallow hole 30B (i.e. the hexagonal shape thereof) in the circumferential direction about the axial center lines of the holes 30A and 30B. More specifically, the hexagonal shape of the deep hole 30A is offset by 30 degrees from the hexagonal shape of the shallow hole 30B in the circumferential direction.

The arrangements of the hexagonal shapes of the deep hole 30A and the shallow hole 30B can be restated as follows. As illustrated in FIGS. 3Aa and 3Ab, in a lengthwise (longitudinally-extending) portion of the operating portion 30 in which the shallow hole 30B is formed, the shallow hole 30B and the deep hole 30A, which are two holes having regular hexagonal cross-sections that are both of the same size, are formed overlaying each other in a state in which the angles of the respective hexagonal shapes are offset by 30 degrees. Accordingly, as illustrated in FIGS. 2Ad1, 2Bd1, and 3B1, when viewed along the longitudinal direction of the rotation assistance tool 10, it can be said that the shallow hole 30B has a cross-section that is similar to the outline (outer contour) of a flower having twelve petals. Alternately stated, within the axial range (axial length) of the shallow hole 30B, the first hexagon (of the deep hole 30A) is rotationally offset from the second hexagon (of the shallow hole 30B) by 30 degrees; thus, a cross-section through the portion of the operating portion 30 that includes the shallow hole 30B is a 12 point (12 vertex) star polygon, which is also known as a dodecagram, more specifically a regular dodecagram.

As described above with reference, e.g., to FIG. 2Bd2, etc., the deep hole 30A has a regular hexagonal cross-section, and as illustrated, e.g., in FIG. 2Bc, the size (diameter or cross-sectional width) of the deep hole 30A is larger than the size (diameter or cross-sectional width) of the through hole 22. In other words, the length of one pair of sides that face each other in the regular hexagonal shape of the deep hole 30A is longer than the diameter of the through hole 22. Accordingly, as illustrated in FIG. 3Ab, a bottom portion 32A of the deep hole 30A (FIGS. 2Ac and 2Bc) has a regular hexagonal shape with a circular hole in the middle. Also, as illustrated in FIGS. 3Aa and 3Ab, bottom portions (steps, shoulders) 32B of the shallow hole 30B (FIGS. 2Ac and 2Bc) define the shape of six small triangles obtained by two regular hexagonal shapes having the same size being overlaid concentrically and offset about their common axial center line by 30 degrees, such that the corners of one regular hexagon protrude out from the sides of the other regular hexagon.

As illustrated, e.g., in FIG. 4Ac, the depth of the deep hole 30A (i.e. the axial length from a distal end of the operating portion 30 to the bottom portion 32A-see FIG. 2Ac) may be greater than a depth that corresponds to (equals) the thickness of the two nuts (the main nut 70A and the jam nut 70B), i.e., the total thickness (length) of both nuts 70A and 70B in the axial direction of the tool 10. Conversely, as illustrated, e.g., in FIG. 4Bc, the depth of the shallow hole 30B (i.e. the axial length from the distal end of the operating portion 30 to the bottom portions 32B) corresponds to (is the same as or less than) the thickness of one nut (jam nut 70B), which is to say that the depth thereof is the same or approximately the same as the thickness thereof. Preferably, the depth of the shallow hole 30A (in particular, the distance of the bottom portions 32B from the longitudinal end of the operating portion 30) is equal to or less than the depth of one nut, so that two nuts cannot be (are prevented from being) fitted into the shallow hole 30A, as will be further explained below. Here, it is noted that the bottom portions 32B are preferably each a flat, triangular shaped surface that extends in a plane perpendicular to central axial line of the rotation assistance tool 10 and serve to block further insertion of a nut in the axial direction thereof.

As illustrated, e.g., in FIGS. 2Aa, 2Ba, 3Aa, groove portions (grooves) 25A and 25B are formed as indicators on the peripheral wall (outer) surface of the main body portion 20 and respectively correspond to the deep hole 30A and the shallow hole 30B, as will be further described below.

On the peripheral wall (outer) surface of the main body portion 20, the groove portions corresponding to the deep hole 30A (i.e. the deep-hole-corresponding groove portions 25A) are formed to have an axial length that corresponds to the depth (axial length) of the deep hole 30A and are respectively formed at positions corresponding to the six apices (vertices) of the deep hole 30A (having the regular hexagonal cross-section, as described above). That is, each of the deep-hole-corresponding groove portions 25A axially extends from the distal end (longitudinal end) of the operating portion 30 to an axial position corresponding to the bottom portion 32A of the deep hole 30A.

Similarly, on the peripheral wall (outer) surface of the main body portion 20, the groove portions corresponding to the shallow hole 30B (i.e. the shallow-hole-corresponding groove portions 25B) are formed to have an axial length that corresponds to the depth of the shallow hole 30B and are respectively formed at positions corresponding to the six apices (vertices) of the shallow hole 30B (also having the regular hexagonal cross-section, as described above) that are offset from the six apices (vertices) of the deep hole 30A by 30 degrees. That is, each of the shallow-hole-corresponding groove portions 25B axially extends from the distal end (longitudinal end) of the operating portion 30 to a position corresponding to the axial position of the bottom portions 32B of the shallow hole 30B.

As illustrated in FIGS. 3B1 to 3B3, the cross-sections (e.g., the circumferential widths and/or the radial depths) of the deep-hole-corresponding groove portions 25A are preferably larger than the cross-sections (e.g., the circumferential widths and/or the radial depths) of the shallow-hole-corresponding groove portions 25B. That is, the deep-hole-corresponding groove portions 25A are preferably wider in the circumferential direction and/or deeper in the radial direction than the shallow-hole-corresponding groove portions 25B.

Due to the above-described configurations of the groove portions 25A and 25B, a user of the rotation assistance tool 10 can visually and/or tactilely identify and distinguish the deep-hole-corresponding groove portions 25A and the shallow-hole-corresponding groove portions 25B. Therefore, the user can easily determine whether one or two nuts are being fitted into the deep hole 30A (by aligning the vertices of the hexagonal(s) with the deep-hole-corresponding groove portions 25A) or whether one nut is being fitted into the shallow hole 30B (by aligning the vertices of the hexagonal nut with the shallow-hole-corresponding groove portions 25B).

Returning to, e.g., FIGS. 2Aa, 2Ba, 3Aa, a large number of slip-proof groove portions (anti-slip grip portions) 26 are formed in a portion of the peripheral wall (outer) surface of the main body portion 20 that corresponds to approximately one-half of the deep hole 30A on the bottom portion 32A side. The slip-proof groove portions 26 also extend along the lengthwise (axial) direction of the main body portion 20. As illustrated in FIGS. 3B1 and 3B3, the cross-sections of the slip-proof groove portions 26 are smaller than the cross-sections of the shallow-hole-corresponding groove portions 25B. That is, the slip-proof groove portions 26 are narrower and also shallower than the shallow-hole-corresponding groove portions 25B. Also, the slip-proof groove portions 26 differ from the deep-hole-corresponding groove portions 25A and the shallow-hole-corresponding groove portions 25B with regard to the positions and the number thereof that are formed, as described above. Accordingly, the tool user can visually and/or tactilely distinguish the deep-hole-corresponding groove portions 25A and the shallow-hole-corresponding groove portions 25B from the slip-proof groove portions 26. In the alternative to straight grooves, the slip-proof groove portions 26 could be formed, e.g., helically or in a knurled pattern.

As described above with reference to FIGS. 5Aa to 5Bb, the driven portion 40 is configured to be manipulated (rotationally driven) by the hand wrench 90a (FIGS. 5Aa-5Ab) or the ratchet socket wrench 90b FIGS. 5Ba-5Bb). For this purpose, the driven portion 40 includes a first driven portion 40a and a second driven portion 40b.

More specifically, the first driven portion 40a is a hexagonal post. That is, the outer shape of the first driven portion 40a is a regular hexagonal in cross-section; the external shape of the first driven portion 40a corresponds to a short shaft that extends along the axial direction of the rotation assistance tool 10. When an open fitting portion (open end) 92a of the open-end wrench 90a is mated with the first driven portion 40a (FIG. 5Ab), the first driven portion 40a can be turned (rotated) by pivoting the open-end wrench 90a. Although an open-end wrench 90A is shown in FIGS. 5Aa and 5Ab, of course a ring-shaped wrench also can be used to rotate the rotation assistance tool 10.

The second driven portion 40b is a square hole. That is, the second driven portion 40b opens at the second end portion (second longitudinal end) of the rotation assistance tool 10, has a square cross-section, and has a hollow shape that extends along the axial direction of the rotation assistance tool 10. When a square post 92b of the square-head (square drive) socket wrench 90b is fitted into the second driven portion 40b (FIG. 5Bb), the second driven portion 40b can be turned by pivoting the square-head socket wrench 90b.

Next, a method of using, as well as advantageous functions and effects, of the rotation assistance tool 10 of the above-described first embodiment will be described. As illustrated in FIGS. 6a and 6b, in order to improve the efficiency of tightening the main nut 70A and the jam nut 70B onto the bolt 60, both nuts 70A and 70B are first preferably tightened at the same time using the deep hole 30A, as described above; thereafter only the jam nut 70B is tightened using the shallow hole 30A.

More specifically, first, the main nut 70A and the jam nut 70B are both tightened at the same time. That is, first, as illustrated in FIG. 4Aa, the main nut 70A and the jam nut 70B are positioned so as to be proximal to the bolt 60, and also the phases (outer contours, vertices) of both nuts 70A and 70B are matched. That is, both nuts 70A and 70B are placed in a state in which the hexagonal shapes thereof are aligned in the axial direction. Then, as illustrated in FIGS. 4Ab and 4Ac, the rotation assistance tool 10 is moved toward both nuts 70A and 70B, and both nuts 70A and 70B are fitted (inserted) into the deep hole 30A of the operating portion 30 of the rotation assistance tool 10. At this time, the tool user visually and/or tactilely recognizes the deep-hole-corresponding groove portions 25A, aligns the deep hole 30A with both nuts 70A and 70B and axially moves the operating portion 30 such that both nuts 70A and 70B enter the deep hole 30A.

In this state, as illustrated in FIGS. 5Aa to 5Bb, the open-end wrench 90a (FIGS. 5Aa and 5Ab) or the square-head socket wrench 90b (FIGS. 5Ba and 5Bb) acts on (pivots) the driven portion 40 (the first driven portion 40a or the second driven portion 40b) to turn the rotation assistance tool 10 in a tightening direction about the central axis thereof. Thus, both nuts 70A and 70B (FIG. 4Ac) can be efficiently tightened at the same time, such that the main nut 70A is positioned at its predetermined position, while the jam nut 70B is positioned approximately at its predetermined position.

Next, the jam nut 70B alone is tightened. That is, first, as illustrated in FIG. 4Aa, the rotation assistance tool 10 is moved away from the nuts 70A and 70B, along the axial direction of the bolt 60, such that both nuts 70A and 70B exit the deep hole 30A.

Next, as illustrated in FIG. 4Ba, either the jam nut 70B is turned (rotated) 30 degrees about the axis of the bolt 60 relative to the rotation assistance tool 10 or the rotation assistance tool 10 is turned (pivoted) 30 degrees relative to the jam nut 70B. As illustrated in FIGS. 4Bb and 4Bc, the rotation assistance tool 10 is then moved toward the jam nut 70B, and the jam nut 70B is fitted into the shallow hole 30B of the operating portion 30 of the rotation assistance tool 10. At this time, the tool user visually and/or tactilely recognizes the shallow-hole-corresponding groove portions 25B, aligns the shallow hole 30B with the jam nut 70B and axially moves the operating portion 30 such the jam nut 70B enters (mates with) the shallow hole 30B.

In this state, as described above with reference to FIGS. 5Aa to 5Bb, the open-end wrench 90a (FIGS. 5Aa and 5Ab) or the square-head socket wrench 90b (FIGS. 5Ba and 5Bb) acts on (pivots, turns) the driven portion 40 (the first driven portion 40a or the second driven portion 40b) to turn the rotation assistance tool 10 in the tightening direction about the axis thereof. As a result, only the jam nut 70B (FIG. 4Bc) is tightened until the jam nut 70B is in close contact (pressure contact) against the main nut 70A, thereby reducing the likelihood of loosening of the main nut 70A. That is, by tightly pressing the jam nut 70B against the main nut 70A, the main nut 70A is impeded or prevented from loosening.

By using the rotation assistance tool 10 as described above, the following advantages and effects are achieved. As described above, both of the nuts 70A and 70B (FIGS. 4Aa to 4Bc) can both be rotated by the open-end wrench 90a (FIGS. 5Aa and 5Ab) or the square-head socket wrench 90b (FIGS. 5Ba and 5Bb) via the rotation assistance tool 10. FIGS. 6a and 6b illustrate an example of the square-head socket wrench 90b (FIGS. 5Ba and 5Bb) being used to perform this initial tightening of both nuts 70A and 70B.

As illustrated in FIGS. 6a and 6b, the position of the wrench 90b can be spaced apart from the position of the nuts 70A and 70B, due to the rotation assistance tool (socket) 10 being interposed between the nuts 70A and 70B and the wrench 90b. Accordingly, even if there is a complicated arrangement of various types of structural members near the nuts 70A and 70B, the wrench 90b (or 90a) can be driven (rotated, turned) at a position distanced therefrom. This enables the wrench 90b (or 90a) to be pivoted with a larger angle (in an unhindered manner), and the nuts 70A and 70B can be turned by a relatively large angle for each pivoting (rotating) operation (more specifically, a tightening operation thereof) of the wrench 90b (or 90a). Accordingly, rotating (tightening) efficiency of the nuts 70A and 70B can be greatly improved for the initial tightening.

Also, the rotation assistance tool 10 is extremely efficient with regard to rotating the two nuts 70A and 70B (main nut 70A and jam nut 70B) that are serially screwed onto one bolt 60, as described above. As described above with reference to FIGS. 4Aa to 4Bc, both nuts 70A and 70B are first fitted into the deep hole 30A, and then both nuts 70A and 70B are rotated simultaneously using the deep hole 30A until the main nut 70A is positioned at a predetermined (tightened) position relative to the bolt. Thereafter, the operating portion 30 (deep hole 30A) of the rotation assistance tool 10 is removed (withdrawn) from both nuts 70A and 70B, the jam nut 70B is fitted into the shallow hole 30B, and the shallow hole 30B is used to rotate and further tighten only the jam nut 70B. Thus, both nuts 70A and 70B can be efficiently rotated (tightened) using the single rotation assistance tool 10. Here, it is noted that the advantage of providing the shallow hole 30A, which has a depth that is capable of receiving only one nut (i.e. the jam nut 70B), is that the user cannot mistakenly tighten both nuts 70A and 70B when it is desired to only tighten the jam nut 70B. That is, once the main nut 70A is in the desired (tightened) axial position along the length of the bolt 60, the jam nut 70B must then be (further) securely tightened against the main nut 70A, which requires rotation (tightening) of the jam nut 70B relative to the main nut 70A. Because only the jam nut 70B can fit into the shallow hole 30B, it is ensured by using the shallow hole 30B that only the jam nut 70B is tightened (relative to and against the main nut 70B) during the final phase of the tightening process (i.e. without accidentally also tightening the main nut 70A, which could adversely move the main nut 70A away from the optimal location of the main nut 70A). As a result, a single rotation assistance tool (socket) 10 can be used to perform the initial tightening of two nuts (70A and 70B) in an efficient manner as well as the final tightening of only one nut (70B) in an error-free manner, thereby improving work efficiency in situations when both a main nut 70A and a jam nut 70B must be tightened on a bolt 60.

It is noted that the slip-proof groove portions 26 reduce the likelihood of slippage when the fingers of the tool user manipulate the rotation assistance tool 10. Accordingly, the tool user can securely grip the rotation assistance tool 10 when fitting the nuts 70A and 70B into the operating portion 30 onto and/or when removing the nuts 70A and 70B therefrom.

Also, because the deep-hole-corresponding groove portions 25A and/or the shallow-hole-corresponding groove portions 25B can be tactilely recognized by the user's fingertips when fitting (inserting) the nut(s) into the deep hole 30A or the shallow hole 30B, both nuts 70A and 70B or only the jam nut 70B can be easily fitted into one of the predetermined holes (deep hole 30A or shallow hole 30B), without mistaking between the deep hole 30A and the shallow hole 30B.

### Modifications Regarding Deep Hole/Shallow Hole

Modifications of the above-described first embodiment within the scope of the present teachings include the following. For example, in the above-described first embodiment, as described above with reference, e.g., to FIG. 4Ac, the deep hole 30A has a depth that is greater than a depth (distance, axial length) corresponding to the total thickness of the two nuts (main nut 70A and jam nut 70B). However, the length of the deep hole 30A is not limited to this. For example, the depth of the deep hole 30A may correspond to (i.e. equal or substantially equal) the depth (distance, axial length) of the total thickness of the two nuts (main nut 70A and jam nut 70B).

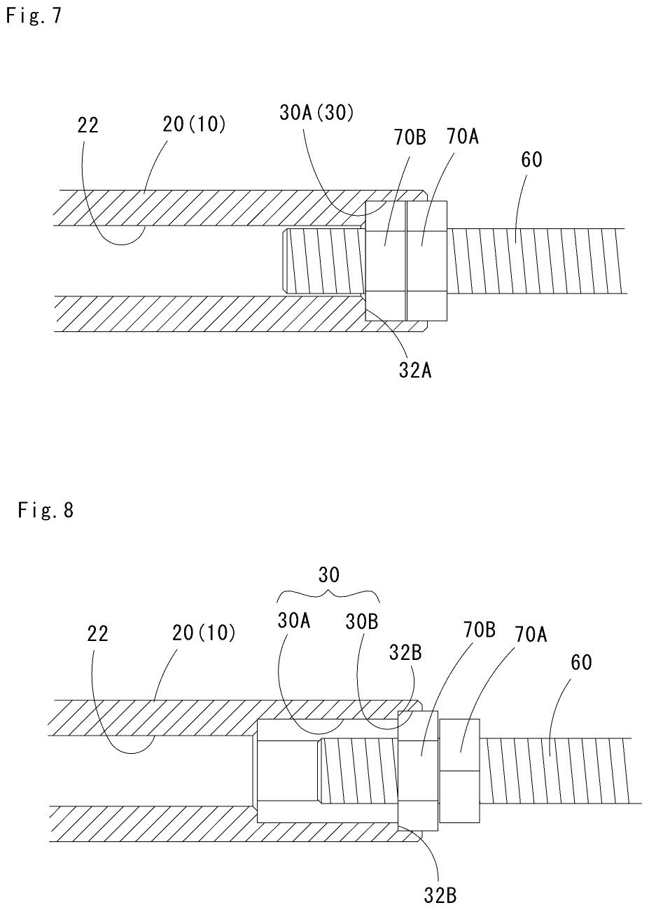

As a further alternative, as illustrated in FIG. 7, the depth of the deep hole 30A may be shallower than the depth corresponding (equal) to the total thickness of the two nuts (main nut 70A and jam nut 70B). In such a modified embodiment, the jam nut 70B will be completely accommodated in the deep hole 30A, whereas the main nut 70A will be only partially accommodated in the deep hole 30A and the remainder thereof will be exposed from the deep hole 30A when the deep hole 30A is used to tighten both nuts 70A and 70B. That is to say, as long as both nuts 70A and 70B can be simultaneously turned (rotated) in the tightening direction about the axis of the rotation assistance tool 10 by using the deep hole 30A, such modifications of the depth of the deep hole 30A are acceptable. Alternately stated, it is sufficient as long as the jam nut 70B can be completely fitted into to the deep hole 30A and the main nut 70A can be at least partially fitted into the deep hole 30A so that both nuts can be tightened at the same time. In other words, it is sufficient for the deep hole 30A to have such a minimum amount of depth, in which the entire jam nut 70B fits in the deep hole 30A and at least enough of the main nut 70A also fits in the deep hole 30A so that both the main nut 70A and the jam nut 70B can be simultaneously rotated (tightened or loosened).

Similarly, as illustrated in FIG. 8, the shallow hole 30B may have a depth that is shallower than the depth corresponding (equal) to the thickness of one nut (jam nut 70B). In such an embodiment, the jam nut 70B will be only partially accommodated in the shallow hole 30B and the remainder thereof will be exposed from the shallow hole 30B. That is, as long as (only) the jam nut 70B can be turned (rotated) in the tightening direction about the axis of the rotation assistance tool 10 using the shallow hole 30B, such modifications of the depth of the shallow hole 30B are acceptable. Alternately stated, it is sufficient as long as the jam nut 70B can be fitted into the shallow hole 30B to such an extent that it can be rotated (tightened or loosened) using the shallow hole 30B. In other words, it is sufficient for the shallow hole 30B to have such a minimum amount of depth.

Also, although the thicknesses (length in axial direction) of the main nut 70A and the jam nut 70B are the same in the above embodiment, the thicknesses of the two nuts 70A and 70B may differ. In this case, the depths of the deep hole 30A and/or the shallow hole 30B can be changed as appropriate, as necessary. For example, the main nut 70A may be thicker in the axial direction than that in the above first embodiment, and/or the jam nut 70B may be thinner in the axial direction than that in the above first embodiment. In such an embodiment, the depth of the shallow hole 30B may be made shallower than that in the above first embodiment, in accordance with different depths (thicknesses) of the nuts 70A and 70B.

### Modifications Regarding Indicators

As described above with reference, e.g., to FIGS. 2Aa and 2Ba, the groove portions 25A and 25B are formed as indicators corresponding to the deep hole 30A and the shallow hole 30B, respectively. However, this specific arrangement is not required, and various types of modifications may be made to the indicators. For example, instead of the groove portions 25A and 25B, protruding portions may be formed corresponding to the deep hole 30A and groove portions may be formed corresponding to the shallow hole 30B, or vice versa. In a further alternative, both of the groove portions 25A and 25B may instead be formed as protruding portions, whereby the deep hole 30A and the shallow hole 30B can be identified by differences in the length thereof and/or the size of the cross-section thereof, or the like.

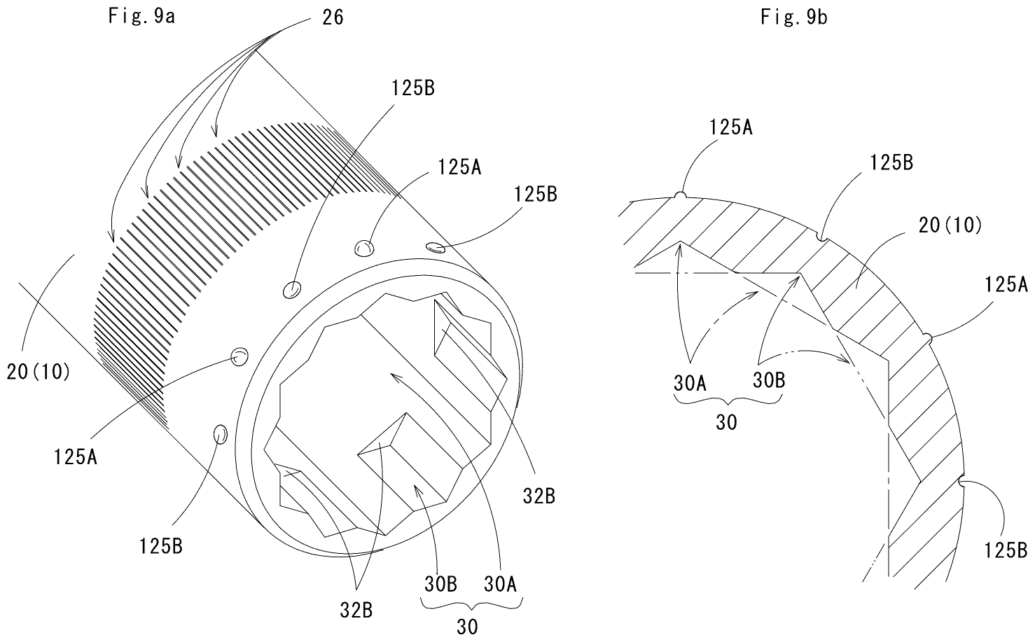

As a further modification, as illustrated in FIGS. 9a and 9b, convex portions 125A that are substantially hemispherical may be formed corresponding to the deep hole 30A, and concave portions 125B that are substantially hemispherical may be formed corresponding to the shallow hole 30B. In this case, the convex portions 125A and the concave portions 125B may be formed at the same length position on the operating portion 30 as illustrated in FIGS. 9a and 9b, or may be formed at different length positions. Also, conversely from the above, concave portions may be formed corresponding to the deep hole 30A and protruding portions may be formed corresponding to the shallow hole 30B. Also, convex portions or concave portions may be formed for both of the deep hole 30A and the shallow hole 30B, whereby the deep hole 30A and the shallow hole 30B can be identified by differences in the sizes thereof or the like. Further, convex portions (including protruding portions) or concave portions (including groove portions) may be formed corresponding to only one of the deep hole 30A and the shallow hole 30B.

Further, the particular form(s) (shape(s)) of such convex portions (including protruding portions) and/or such concave portions (including groove portions), which are formed as indicators on the peripheral wall (outer) surface of the main body portion 20 and enable the deep hole 30A and/or the shallow hole 30B to be recognized visually and/or tactilely, as described above, is (are) not restrictive. For example, the following forms (shapes) may be utilized with the present teachings as well. That is, the forms (shapes) of the indicators on the peripheral wall surface of the main body portion 20 may be, e.g., letters, shapes, patterns, colors, and/or combinations thereof, as long the user can readily distinguish between the deep hole 30A and the shallow hole 30B visually and/or tactilely by viewing and/or touching the respective indicators. For example, the indicators for the deep hole 30A and/or shallow hole 30B may be configured to be visually recognized by the tool user. Simply stated, the rotation assistance tool 10 preferably has one or more first indicators that indicate the location of the vertices of the hexagonal internal shape of the deep hole 30A and one or more second indicators that indicate the location of the vertices of the hexagonal internal shape of the shallow hole 30B. It is sufficient if the user can distinguish between the one or more first indicators and the one or more second indicators visually or by touch, although embodiments are preferable in which the two sets of indicators can be distinguished both visually and tactilely.

Although specific dimensions (in particular, the axial lengths) of the deep hole 30A and the shallow hole 30B will typically depend on the particular application of the present invention, the following representative, non-limiting dimensions are disclosed. Specifically, the depth of the shallow hole 30B is preferably, e.g., in the range of 1-5 millimeters and the depth of the deep hole 30A is preferably greater than 3 millimeters, as long as the deep hole 30A is deeper (has a greater axial length) than the shallow hole 30B. As noted above, these depths (axial lengths) are taken starting from the (first) longitudinal end of the operating portion 30 in a direction toward the (second) longitudinal end of the driven portion (drive end) 40.

The present invention is not limited to the plurality of examples described above, and it is needless to say that the present invention can be implemented in forms with various types of changes applied on the basis of knowledge of one skilled in the art.

That is, representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved nut rotation assistance tools (sockets) and methods of making and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Additional aspects of the present teachings include, but are not limited to:

Aspect 1. A nut rotation assistance tool that assists in rotating a first nut and a second nut serially arranged on the same axial line using a nut rotation tool, wherein
the nut rotation assistance tool extends in one direction and has a first end portion and a second end portion, an operating portion to which the first nut and the second nut are fit is formed at the first end portion and an driven portion that receives a turning operation of the nut rotation tool is formed at the second end portion,
the operating portion is formed of (has) a deep hole and a shallow hole,
the deep hole has a depth that corresponds to or is deeper than a total thickness of the first nut and the second nut that are in a state in which phases in a direction about the same axial line match each other,
the shallow hole corresponds to only the second nut, and
the deep hole and the shallow hole are formed concentrically and also in a state in which phases in a direction about axial center lines thereof do not match each other.

Aspect 2. A nut rotation assistance tool that assists in rotating a first nut and a second nut serially arranged on the same axial line using a nut rotation tool, wherein
the nut rotation assistance tool extends in one direction and has a first end portion and a second end portion, an operating portion to which the first nut and the second nut are fit is formed at the first end portion and a driven portion that receives turning operation of the nut rotation tool is formed at the second end portion,
the operating portion is formed of (has) a deep hole and a shallow hole,
with respect to the first nut and the second nut that are in a state in which phases in a direction about the axial line match each other, the deep hole accommodates the second nut and also at least part of the first nut, and both of these nuts are turned on the basis of turning of the nut rotation assistance tool in a direction about its own axis,
at least part of the second nut is accommodated in the shallow hole, and the second nut is turned on the basis of turning of the nut rotation assistance tool in the direction about its own axis, and
the deep hole and the shallow hole are formed concentrically and also in a state in which phases in a direction about axial center lines thereof do not match each other.

Aspect 3. The nut rotation assistance tool according to the above Aspect 1 or 2, wherein an indicator for a user to identify the deep hole and the shallow hole by sight and/or sense of touch of the user is formed on a main body portion.

Aspect 4. The nut rotation assistance tool according to the above Aspect 1 or 2, wherein a convex portion and/or a concave portion is formed on a peripheral wall surface of a main body portion, corresponding to at least one of the deep hole and the shallow hole.

Aspect 5. The nut rotation assistance tool according to the above Aspect 1 or 2, wherein a protruding portion and/or a groove portion having a difference in length corresponding to difference in depths of the deep hole and the shallow hole is formed on a peripheral wall face of a main body portion, corresponding to the deep hole and the shallow hole.

Aspect 6. The nut rotation assistance tool according to any of the above Aspects, wherein the driven portion includes a polygonal post and a polygonal hole formed in the polygonal post.

What is claimed is:

1. A nut rotation assistance tool configured to assist in rotating a first nut and a second nut that are serially arranged on the same axial line, comprising:
a main body portion that extends in a longitudinal direction and has a first longitudinal end portion and a second longitudinal end portion,
an operating portion located at the first longitudinal end portion and configured to receive the first nut and the second nut, and
a driven portion located at the second longitudinal end portion and configured to receive a turning force from a nut rotating tool around an axial center line of the main body portion,
wherein:
the operating portion includes a deep polygonal hole and a shallow polygonal hole,
the deep polygonal hole has a first axial depth that corresponds to or is deeper than a total thickness of the first nut and the second nut that are disposed in a state in which outer contours of the first and second nuts are aligned along the same axial line,
the shallow polygonal hole has a second depth that corresponds to only the thickness of the second nut,
the deep polygonal hole and the shallow polygonal hole overlap in an axial direction of the nut rotation assistance tool,
the deep polygonal hole and the shallow polygonal hole have the same polygonal internal shape, and
the polygonal internal shape of the deep polygonal hole is circumferentially offset from the polygonal internal shape of the shallow polygonal hole about the axial center line of the main body portion.

2. The nut rotation assistance tool according to claim 1, wherein at least one indicator is defined on a peripheral outer surface of the main body portion or of the operating portion and is configured such that a tool user can visually and/or tactilely identify the locations of vertices of the polygonal internal shape of the deep polygonal hole and the locations of vertices of the polygonal internal shape of the shallow polygonal hole that are circumferentially offset from the vertices of the deep polygonal hole.

3. The nut rotation assistance tool according to claim 1, wherein at least one convex portion and/or at least one concave portion is defined on a peripheral outer surface of the main body portion or of the operating portion, corresponding to at least one of the deep polygonal hole and the shallow polygonal hole.

4. The nut rotation assistance tool according to claim 1, wherein at least one protruding portion and/or at least one groove portion having a difference in length corresponding to difference in depths of the deep polygonal hole and the shallow polygonal hole is defined on a peripheral outer surface of the main body portion or of the operating portion, corresponding to the deep polygonal hole and the shallow polygonal hole.

5. The nut rotation assistance tool according to claim 1, wherein the driven portion comprises:
a polygonal post extending from the main body portion, and
a polygonal hole formed in the polygonal post.

6. The nut rotation assistance tool according to claim 1, wherein the nut rotation assistance tool is in the form of a socket configured to be rotated by the nut rotating tool, which is a wrench.

7. The nut rotation assistance tool according to claim 1, wherein:
the polygonal internal shape of the deep polygonal hole is a first regular hexagon;
the polygonal internal shape of the shallow polygonal hole is a second regular hexagon that is circumferentially offset by 30 degrees from the first regular hexagon around the axial center line; and
the first and second regular hexagon have the same dimensions in a cross-section perpendicular to the axial center line.

8. The nut rotation assistance tool according to claim 1, wherein:
a first cross-section perpendicular to the axial center line through a portion of the operating portion containing the deep and shallow polygonal holes is a regular dodecagram shape; and
a second cross-section perpendicular to the axial center line through a portion of the operating portion containing the deep polygonal hole that does not axially overlap the shallow polygonal hole is a regular hexagonal shape.

9. The nut rotation assistance tool according to claim 8, wherein:
the deep polygonal hole has a first axial depth of at least 3 millimeters; and
the shallow polygonal hole has a second axial depth of 1-5 millimeters, with the proviso that the first axial depth is greater than the second axial depth.

10. The nut rotation assistance tool according to claim 9, wherein:
the driven portion comprises:
a polygonal post extending from the main body portion, and
a polygonal hole formed in the polygonal post;
the nut rotation assistance tool is in the form of a socket configured to be rotated by the nut rotating tool, which is a wrench;
the polygonal internal shape of the deep polygonal hole is a first regular hexagon;
the polygonal internal shape of the shallow polygonal hole is a second regular hexagon that is circumferentially offset by 30 degrees from the first regular hexagon around the axial center line;
the first and second regular hexagon have the same dimensions in a cross-section perpendicular to the axial center line; and
at least one indicator is defined on a peripheral outer surface of the main body portion or of the operating portion and is configured such that a tool user can visually and/or tactilely identify the locations of vertices of the polygonal internal shape of the deep polygonal hole and the locations of vertices of the polygonal internal shape of the shallow polygonal hole that are circumferentially offset from the vertices of the deep polygonal hole.

11. A nut rotation assistance tool configured to assist in rotating a first nut and a second nut that are serially arranged on the same axial line, comprising:
a main body portion that extends in a longitudinal direction and has a first longitudinal end portion and a second longitudinal end portion,
an operating portion located at the first longitudinal end portion and configured to receive the first nut and the second nut, and
a driven portion located at the second longitudinal end portion and configured to receive a turning force from a nut rotating tool around an axial center line of the main body portion,
wherein:
the operating portion includes a deep polygonal hole and a shallow polygonal hole,
the deep polygonal hole has a first axial depth sufficient to entirely accommodate the second nut and also at least a portion of the first nut, such that the first and second nuts are turnable together when the first and second nuts are received in the deep polygonal hole and the nut rotation assistance tool is rotated around the axial center line,
the shallow polygonal hole has a second axial depth in a range that is (i) sufficient to accommodate at least a portion of the second nut (ii) but no greater than the axial thickness of the second nut, such that only the second nut is turnable when the second nut is partially or completely received in the shallow hole and the nut rotation assistance tool is rotated around the axial center line, and
the deep polygonal hole and the shallow polygonal hole overlap in an axial direction of the nut rotation assistance tool,
the deep polygonal hole and the shallow polygonal hole have the same polygonal internal shape, and
the polygonal internal shape of the deep polygonal hole is circumferentially offset from the polygonal internal shape of the shallow polygonal hole about the axial center line.

12. The nut rotation assistance tool according to claim 11, wherein at least one indicator is defined on a peripheral outer surface of the main body portion or of the operating portion and is configured such that a tool user can visually and/or tactilely identify the locations of vertices of the polygonal internal shape of the deep polygonal hole and the locations of vertices of the polygonal internal shape of the shallow polygonal hole that are circumferentially offset from the vertices of the deep polygonal hole.

13. The nut rotation assistance tool according to claim 11, wherein at least one convex portion and/or at least one concave portion is defined on a peripheral outer surface of the main body portion or of the operating portion, corresponding to at least one of the deep polygonal hole and the shallow polygonal hole.

14. The nut rotation assistance tool according to claim 11, wherein at least one protruding portion and/or at least one groove portion having a difference in length corresponding to difference in depths of the deep polygonal hole and the shallow polygonal hole is defined on a peripheral outer surface of the main body portion or of the operating portion, corresponding to the deep polygonal hole and the shallow polygonal hole.

15. The nut rotation assistance tool according to claim 11, wherein the driven portion comprises:
a polygonal post extending from the main body portion, and
a polygonal hole formed in the polygonal post.

16. The nut rotation assistance tool according to claim 11, wherein the nut rotation assistance tool is in the form of a socket configured to be rotated by the nut rotating tool, which is a wrench.

17. The nut rotation assistance tool according to claim 11, wherein:
the polygonal internal shape of the deep polygonal hole is a first regular hexagon;
the polygonal internal shape of the shallow polygonal hole is a second regular hexagon that is circumferentially offset by 30 degrees from the first regular hexagon around the axial center line; and
the first and second regular hexagon have the same dimensions in a cross-section perpendicular to the axial center line.

18. The nut rotation assistance tool according to claim 11, wherein:
a first cross-section perpendicular to the axial center line through a portion of the operating portion containing the deep and shallow polygonal holes is a regular dodecagram shape; and
a second cross-section perpendicular to the axial center line through a portion of the operating portion containing the deep polygonal hole that does not axially overlap the shallow polygonal hole is a regular hexagonal shape.

19. The nut rotation assistance tool according to claim 18, wherein:
the deep polygonal hole has a first axial depth of at least 3 millimeters; and
the shallow polygonal hole has a second axial depth of 1-5 millimeters, with the proviso that the first axial depth is greater than the second axial depth.

20. The nut rotation assistance tool according to claim 19, wherein:
the driven portion comprises:
a polygonal post extending from the main body portion, and
a polygonal hole formed in the polygonal post;
the nut rotation assistance tool is in the form of a socket configured to be rotated by the nut rotating tool, which is a wrench;
the polygonal internal shape of the deep polygonal hole is a first regular hexagon;
the polygonal internal shape of the shallow polygonal hole is a second regular hexagon that is circumferentially offset by 30 degrees from the first regular hexagon around the axial center line;
the first and second regular hexagon have the same dimensions in a cross-section perpendicular to the axial center line; and
at least one indicator is defined on a peripheral outer surface of the main body portion or of the operating portion and is configured such that a tool user can visually and/or tactilely identify the locations of vertices of the polygonal internal shape of the deep polygonal hole and the locations of vertices of the polygonal internal shape of the shallow polygonal hole that are circumferentially offset from the vertices of the deep polygonal hole.
